(19) United States
(12) Patent Application Publication
(10) Pub. No.: US 2007/0190948 A1
(43) Pub. Date: Aug. 16, 2007

(54) Radio frequency module

(75) Inventor: I-Ru Liu, Taipei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/352,996

(22) Filed: Feb. 14, 2006

(51) Int. Cl. H04B 1/44

(52) U.S. Cl. 455/78

(57) ABSTRACT

A radio frequency (RF) module cooperates with an antenna and a digital signal processing (DSP) module. The DSP module outputs a first digital signal to the RF module, and the antenna outputs a second RF signal to the RF module. The RF module comprises a digital analog hybrid signal processing unit and an analog signal processing unit. In this case, the digital analog hybrid signal processing unit converts the first digital signal into a first analog signal or converts a second analog signal into a second digital signal, and outputs the second digital signal to the DSP module. The analog signal processing unit generates a first RF signal in accordance with the first analog signal or generates the second analog signal in accordance with the second RF module, and outputs the first RF signal to the antenna or outputs the second analog signal to the digital analog hybrid signal processing unit.

### BACKGROUND OF THE INVENTION

1. Field of Invention

The invention relates to a radio frequency (RF) module and, in particular to a RF module capable of processing digital signals and to the applications to outdoor MIMO apparatuses for WiFi or WiMAX.

2. Related Art

The rapid development in radio transmission has brought us many products and technologies for multiple-band transmissions. Many new products are equipped with wireless transmission functions to satisfy consumer's needs. The RF module is used to convert electromagnetic (EM) signals received by an antenna into low-frequency signals in a wireless transmission system. The low-frequency signals are then further processed by a rear-end unit. The low-frequency signals output by the rear-end unit are converted into EM signals and sent to the antenna. Therefore, the design of the RF module determines the quality of signal transmissions.

As shown in FIG. 1, the conventional RF module 1 cooperates with an antenna 21 and a base band processing module 22. The antenna 21 generates a first RF signal RF_1. The base band processing module 22 is electrically coupled with the RF module 1 via a cable. The RF module 1 includes a transceiver 11 and a selector 12.

The transceiver 11 receives a second analog signal AS_2 from the base band processing module 22 via the cable and converts the second analog signal AS_2 into a second RF signal RF_2, and converts the first RF signal RF_1 into a first analog signal AS_1 and sends the first analog signal AS_1 to the base band processing module 22 via the cable.

The selector 12 is electrically coupled to the antenna 21 and the transceiver 11. The selector 12 selects to receive the first RF signal RF_1 from the antenna 21 or to transmit the second RF signal RF_2 to the antenna 21.

However, when the distance between the RF module 1 and the base band processing module 22 is long, this is the case when the outdoor multi-input-multi-output (MIMO) wireless products use Spatial Diversity or Spatial Multiplexing technologies and the antenna spacings have to be much greater than wavelength to raise either diversity or multiplexing gains which result in range extension or throughput enhancement, the analog signals transmitted between them are likely to be interfered with outside interference or interference among themselves due to poor cable shielding or isolation, deteriorating the signal waveforms. Moreover, a longer cable may produce excessive ohmic and/or dielectric losses, in addition to unpredictable capacitive impedance or inductive impedance due to cable damage, resulting in larger cable insertion loss. This will reduce the signal quality, signal reliability and signal integrity of analog signals.

Therefore, how to provide a RF module that can solve the problem of lowering signal quality and reducing the signal integrity in analog signal transmissions is an important subject of the field.

### SUMMARY OF THE INVENTION

In view of the above, the invention is to provide a RF module capable of processing digital signals.

To achieve the above-mentioned, the disclosed RF module according to the invention cooperates with an antenna and a digital signal processing (DSP) module. The DSP module outputs a first digital signal to the RF module, and the antenna outputs a second RF signal to the RF module. The RF module includes a digital analog hybrid signal processing unit and an analog signal processing unit. In this case, the digital analog hybrid signal processing unit converts the first digital signal to a first analog signal, or converts the second analog signal to a second digital signal. The digital analog hybrid signal processing unit outputs the second digital signal to the DSP module. The analog signal processing unit generates a first RF signal in accordance with the first analog signal, generates the second analog signal in accordance with the second RF signal, outputs the first RF signal to the antenna, and outputs the second analog signal to the digital analog hybrid signal processing unit.

As described above, the RF module in accordance with the invention receives the first digital signal generated by the DSP module and outputs the second digital signal to the DSP module, so that the signal transmission of the RF module is digitized. The digital signal transmission is less likely to be affected or interfered with noises and among themselves. Thus, the communication quality is thus improved.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional RF module;

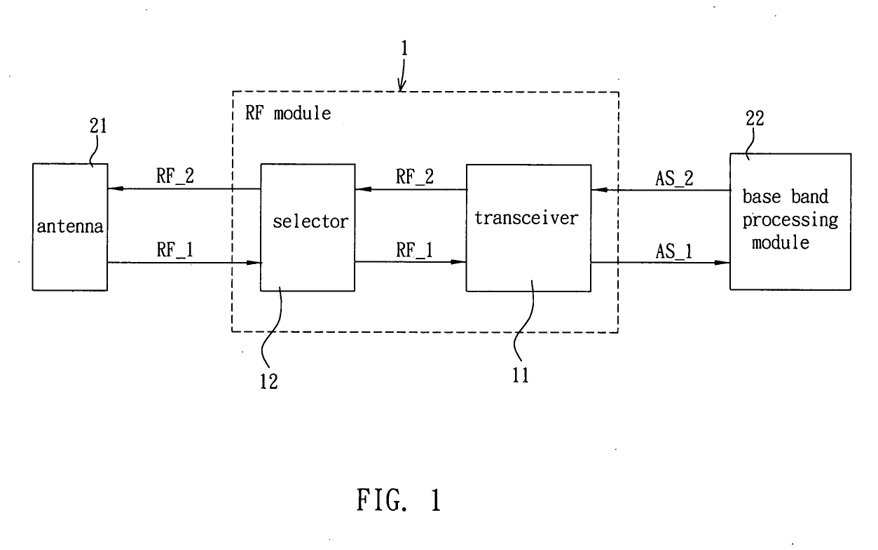

FIG. 2 is a schematic view showing the RF module in the preferred embodiment of the invention;

FIG. 3 is a schematic view showing the digital analog hybrid signal processing unit of FIG. 2;

FIG. 4 is a schematic view showing the analog signal processing unit of FIG. 2; and

FIG. 5 is a schematic view showing the RF module in another embodiment of the invention.

### DETAILED DESCRIPTION OF THE INVENTION

The present invention will be apparent from the following detailed description, which proceeds with reference to the accompanying drawings, wherein the same references relate to the same elements.

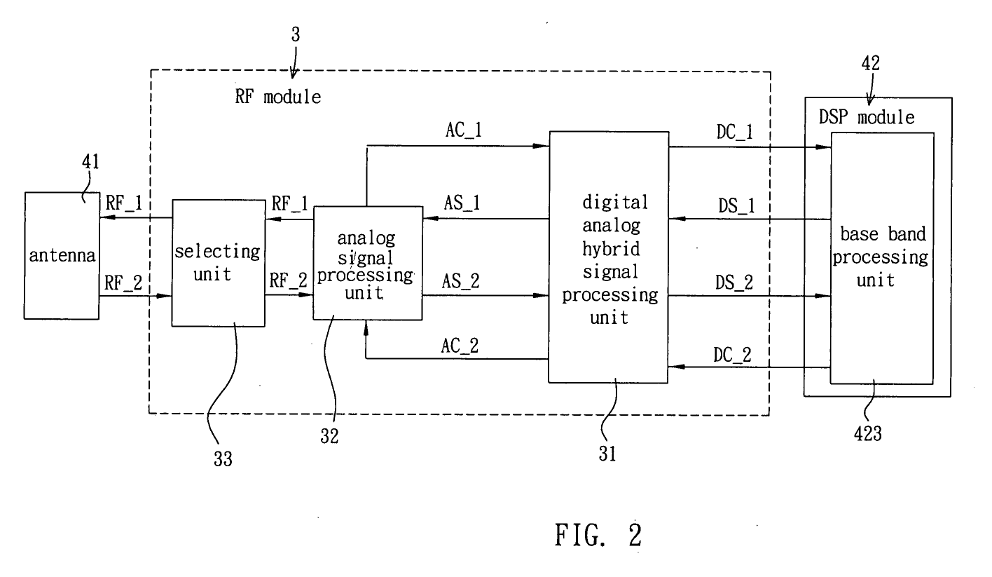

With reference to FIG. 2, the RF module 3 according to a preferred embodiment of the invention cooperates with an antenna 41 and a DSP module 42. Herein, the DSP module 42 outputs a first digital signal DS_1 to the RF module 3. The antenna 41 outputs a second RF signal RF_2 to the RF module 3. In addition, the RF module 3 includes a digital analog hybrid signal processing unit 31 and an analog signal processing unit 32.

The digital analog hybrid signal processing unit 31 converts the first digital signal DS_1 into a first analog signal AS_1 or converts a second analog signal AS_2 into a second digital signal DS_2. The digital analog hybrid signal processing unit 31 outputs the second digital signal DS_2 to the DSP unit 42.

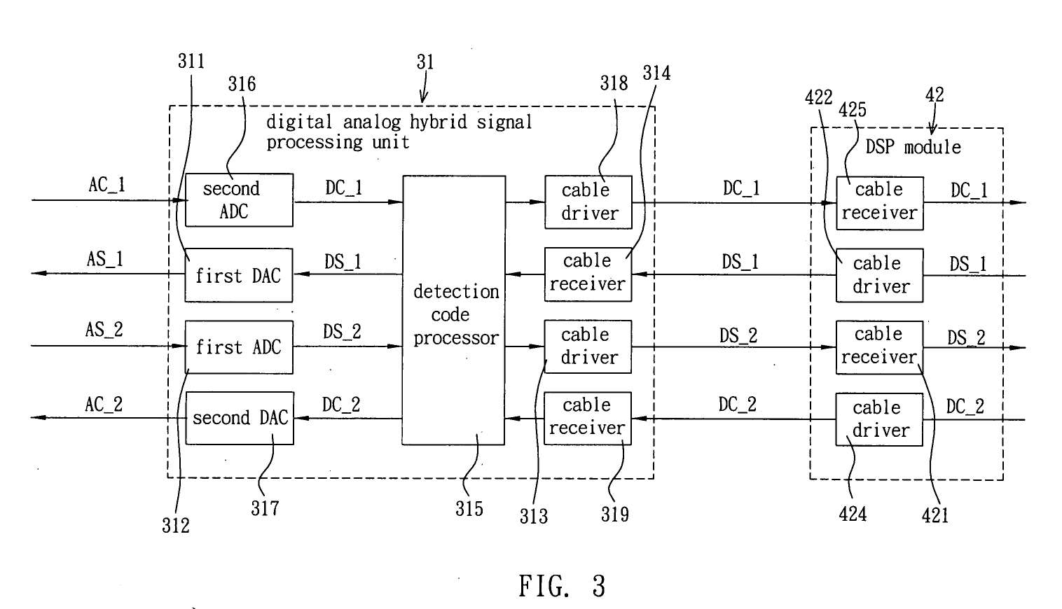

As shown in FIG. 3, the digital analog hybrid signal processing unit 31 includes a first digital-to-analog converter (D/A converter, DAC) 311 and a first analog-to-digital converter (A/D converter, ADC) 312. In this embodiment, the first DAC 311 converts the first digital signal DS_1 into the first analog signal AS_1. The first ADC 312 converts the second analog signal AS_2 into the second digital signal DS_2.

In this embodiment, the digital analog hybrid signal processing unit 31 includes a cable driver 313 and a cable receiver 314. The cable driver 313 amplifies the second digital signal DS_2 and transmits the signal via a cable to a cable receiver 421 of the DSP module 42. Besides, a cable driver 422 of the DSP module 42 amplifies the first digital signal DS_1. In this case, the cable receiver 314 receives the first digital signal DS_1 amplified by the cable driver 422. Herein, the cable receivers 314, 421 are matched with the cable in the impedance. Therefore, by matching between the cable drivers 313, 422, the cable receivers 314, 421 and the cable, it is possible to avoid cable loss caused by capacitive and inductive impedance of the cable that may reduce the signal integrity of the digital signals DS_1, DS_2.

In this embodiment, the digital analog hybrid signal processing unit 31 further includes a detection code processor 315. The detection code processor 315 detects whether the first digital signal DS_1 received by the digital analog hybrid signal processing unit 31 has any error and adds a detection code to the second digital signal DS_2 before sending it to the DSP module 42 via the cable driver 313. The detection code can be checksum. Therefore, the first digital signal DS_1 and the second digital signal DS_2 are processed by the detection code processor 315, so that incorrect signals, i.e. defects or noises, are less likely to enter the RF module 3 and the DSP module 42, thereby improving the signal quality.

With further reference to FIG. 2, the analog signal processing unit 32 generates a first RF signal RF_1 in accordance with the first analog signal AS_1 or generates the second analog signal AS_2 in accordance with the second RF signal RF_2. The analog signal processing unit 32 outputs the first RF signal RF_1 to the antenna 41 or outputs the second analog signal AS_2 to the DSP module 42.

In the current embodiment, the RF module 3 further includes a selecting unit 33 electrically coupled to the antenna 41 and the analog signal processing unit 32. The selecting unit 32 selects to receive the second RF signal RF_2 generated by the antenna 41 or to output the first RF signal RF_1 to the antenna 41. Generally speaking, the selecting unit 33 can be a single pole double throw (SPDT) switch. Besides, the DSP module 42 further includes a base band processing unit 423, which is electrically coupled to the digital analog hybrid signal processing unit 31 via a cable. The first digital signal DS_1 and the second digital DS_2 can be base band signals, respectively.

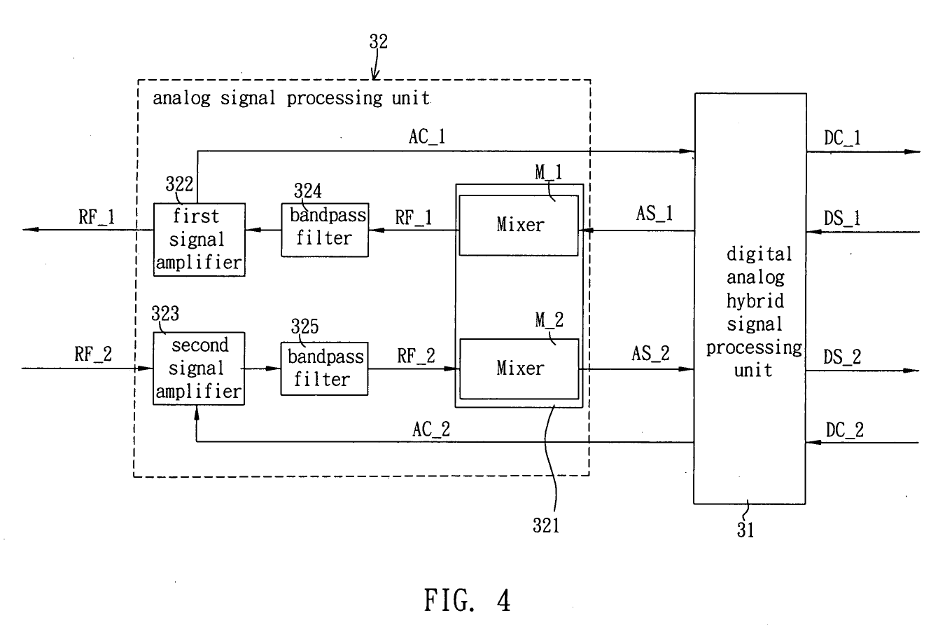

With reference to FIG. 4, the analog signal processing unit 32 includes a transceiver 321, a first signal amplifier 322, a second signal amplifier 323 and bandpass filters 324, 325.

The transceiver 321 receives the first analog signal AS_1 from the digital analog hybrid signal processing unit 31 and converts the first analog signal AS_1 into the first RF signal RF_1, or converts the second RF signal RF_2 into the second analog signal AS_2 and transmits the second analog signal AS_2 to the digital analog hybrid signal processing unit 31. In this embodiment, the transceiver 321 includes two mixers M_1, M_2. The mixer M_1 converts the first analog signal AS_1 into the first RF signal RF_1, and another mixer M_2 converts the second RF signal RF_2 into the second analog signal AS_2. In addition, the first signal amplifier 322 amplifies the first RF signal RF_1 converted by the transceiver 321. The second signal amplifier 323 amplifies the second RF signal RF_2 output by the antenna 41. Generally speaking, the first signal amplifier 322 can be a power amplifier (PA) and the second signal amplifier 323 can be a low noise amplifier (LNA).

In this embodiment, the analog signal processing unit 32 can further control the amplification of signals through gain control. As shown in FIGS. 3 and 4, the second ADC 316 converts a first analog gain control signal AC_1 into a first digital gain control signal DC_1, and transmits the first digital gain control signal DC_1 to the DSP module 42 as the gain control of the first signal amplifier 322. The second DAC 317 converts a second digital gain control signal DC_2 generated by the DSP module 42 into a second analog gain control signal AC_2 and outputs the second analog gain control signal AC_2 to the second signal amplifier 323 as the gain control thereof. As illustrated in FIG. 3, the transmissions of the first digital gain control signal DC_1 and the second gain control signal DC_2 can be the same as the first digital signal DS_1 and the second digital signal DS_2. That is, the first digital gain control signal DC_1 and the second gain control signal DC_2 are processed by the detection code processor 315, the cable drivers 318, 424 and the cable receivers 319, 425.

As shown in FIG. 4, the RF module can be added with a bandpass filter in order to pass signals in a specific band. For example, a bandpass filter 324 is used to capture an expected band of the first RF signal RF_1 or a bandpass filter 325 is used to extract an expected band of the second RF signal RF_2, in order to reduce noise interference.

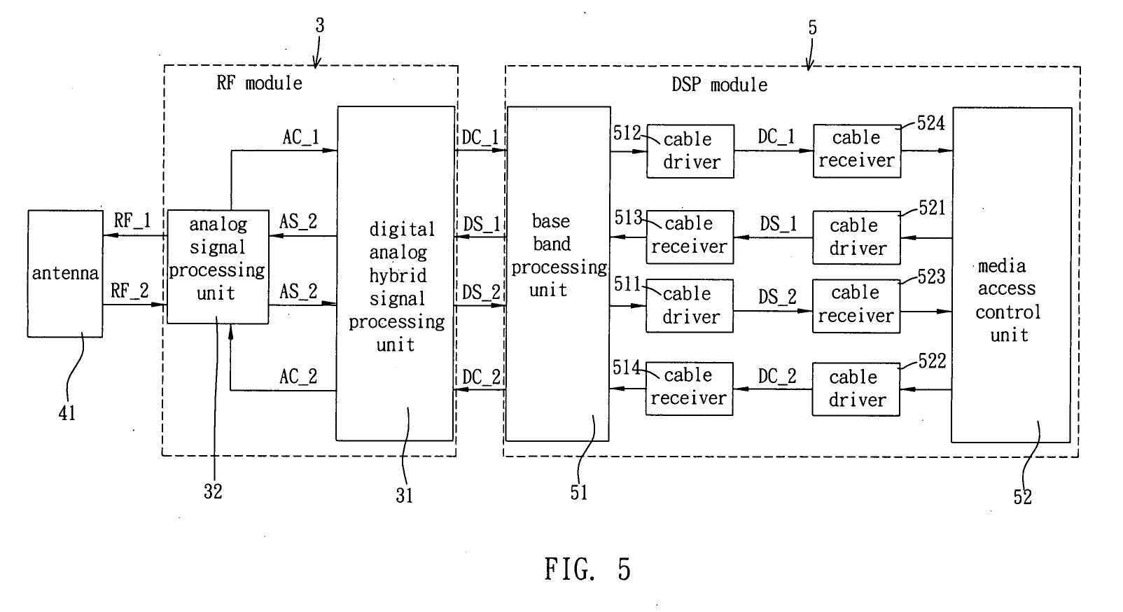

With reference to FIG. 5, the RF module 3 in another embodiment of the invention cooperates with an antenna 41 and a DSP module 5. Herein, the RF module 3 includes a digital analog hybrid signal processing unit 31 and an analog signal processing unit 32. The main structures of the RF module 3 and the antenna 41 are same as the above, and explanation of them is omitted here.

The digital signal processing module 5 includes a base band processing unit 51 and a media access control unit 52.

The base band processing unit 51 outputs the first digital signal DS_1 to the digital analog hybrid signal processing unit 31, which output the second digital signal DS_2 to the base band processing unit 51. The media access control unit 52 is electrically coupled to the base band processing unit 51 via a cable. The first digital signal DS_1, the second digital signal DS_2, the first digital gain control signal DC_1, and the second digital gain control signal DC_2 also can cooperate with the cable drivers 511, 512, 521, 522 and the cable receivers 513, 514, 523, 524 to prevent capacitive and inductive impedance from reducing the signal integrity of the digital signals DS_1, DS_2, DC_1, DC_2.

Finally, the disclosed RF module can be used in different antenna systems. For example, the RF module of the invention can cooperate with a MIMO antenna system. Alternatively, the disclosed RF module can be used in an outdoor antenna system. Moreover, the disclosed RF module can satisfy the band standards of IEEE 802.11 (WiFi), IEEE 802.16 (WIMAX), IEEE 802.20, 3G, B3G, 4G, etc.

In conclusion, the RF module in accordance with the invention receives a first digital signal produced by its DSP module and outputs a second digital signal to the DSP module, so that the signal transmission of the RF module is digitized. The digital signal transmission is less likely to be affected or interfered with noises and among themselves. The combination of cable drivers and cable receivers also help preventing capacitive and inductive impedance of the cables from reducing the integrity of the digital signals. The communication quality is thus improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A radio frequency (RF) module cooperating with an antenna and a digital signal processing (DSP) module, the DSP module outputting a first digital signal to the RF module, the antenna outputting a second RF signal to the RF module, the RF module comprising:
a digital analog hybrid signal processing unit, which converts the first digital signal into a first analog signal or converts a second analog signal into a second digital signal, and outputs the second digital signal to the DSP module; and
an analog signal processing unit, which generates a first RF signal in accordance with the first analog signal or generates the second analog signal in accordance with the second RF signal, and outputs the first RF signal to the antenna or outputs the second analog signal to the digital analog hybrid signal processing unit.

2. The RF module of claim 1, wherein the analog signal processing unit comprises:
a transceiver, which receives the first analog signal from the digital analog hybrid signal processing unit and coverts the first analog signal into the first RF signal, and converts the second RF signal into the second analog signal and transmits the second analog signal to the digital analog hybrid signal processing unit;
a first signal amplifier, which amplifies the first RF signal converted by the transceiver; and
a second signal amplifier, which amplifies the second RF signal output by the antenna.

3. The RF module of claim 2, wherein the first signal amplifier is a power amplifier and the second signal amplifier is a low-noise amplifier.

4. The RF module of claim 2, wherein the digital analog hybrid signal processing unit comprises:
a first digital-to-analog converter (DAC), which converts the first digital signal to the first analog signal; and
a first analog-to-digital converter (ADC), which converts the second analog signal to the second digital signal.

5. The RF module of claim 4, wherein the digital analog hybrid signal processing unit further comprises:
a second ADC, which converts a first analog gain control signal generated by the first signal amplifier into a first digital gain control signal; and
a second DAC, which converts a second digital gain control signal generated by the DSP module into a second analog gain control signal.

6. The RF module of claim 5, wherein the second ADC outputs the first digital gain control signal to the DSP module and the second DAC outputs the second analog gain control signal to the second signal amplifier.

7. The RF module of claim 1, further comprising:
a selecting unit electrically coupled to both the antenna and the analog signal processing unit.

8. The RF module of claim 7, wherein the selecting unit selects to receive the second RF signal generated by the antenna or to output the first RF signal to the antenna.

9. The RF module of claim 7, wherein the selecting unit is a single pole double throw (SPDT) switch.

10. The RF module of claim 1, wherein the digital analog hybrid signal processing unit comprising:
a cable driver, which transmits the second digital signal to the DSP module via a cable; and
a cable receiver, which receives the first digital signal transmitted from the DSP module via the cable.

11. The RF module of claim 1, wherein the digital analog hybrid signal processing unit comprises a detection code processor to detect whether the first digital signal received by the digital analog hybrid signal processing unit has an error and adds a detection code to the second digital signal.

12. The RF module of claim 11, wherein the detection code is a checksum.

13. The RF module of claim 1, wherein the first digital signal and the second digital signal are base band signals.

14. The RF module of claim 13, wherein the DSP module comprises a base band processing unit that outputs the first digital signal to the digital analog hybrid signal processing unit and the digital analog hybrid signal processing unit outputs the second digital signal to the base band processing unit.

15. The RF module of claim 14, wherein the base band processing unit is electrically coupled to the digital analog hybrid signal processing unit via a cable.

16. The RF module of claim 14, wherein the DSP module further comprises a media access control unit electrically coupled to the base band processing unit via a cable.

17. The RF module of claim 1, wherein the RF module is used in a multi-input-multi-output (MIMO) antenna system.

18. The RF module of claim 1, wherein the RF module is used in an outdoor antenna system.
